(19) United States
(12) Patent Application Publication
(10) Pub. No.: US 2018/0351880 A1
(43) Pub. Date: Dec. 6, 2018

(54) PREFIX PROCESSING SYSTEM AND METHOD

(71) Applicant: NANNING FUGUI PRECISION INDUSTRIAL CO., LTD., Nanning (CN)

(72) Inventors: CHIEN-JU HUANG, HsinChu (TW); JUNG-CHUNG TSAI, HsinChu (TW); SHENG-PIN SHEN, HsinChu (TW)

(21) Appl. No.: 15/638,292

(22) Filed: Jun. 29, 2017

(30) Foreign Application Priority Data
May 31, 2017 (CN) 201710399326.X

(51) Int. Cl. H04L 12/935; G06F 9/30; H04L 12/741

(52) U.S. Cl. CPC H04L 49/3009; G06F 9/30185; G06F 17/30; H04L 45/54; H04L 45/745

(57) ABSTRACT

In a network, a system and method implemented by a root router for prefix processing for a connected router renews (by a DHCPv6 server) a delegated IPv6 Prefix of the root router and stores the delegated prefix in the PD table. A bit boundary of the connected router from the PD table is obtained based on a router identifier of the connected router. An IPv6 prefix to the connected router is delegated according to the delegated IPv6 prefix of the root router and the bit boundary.

### FIELD

The subject matter herein generally relates to network routing, in particular to prefix processing in a root router.

### BACKGROUND

A plurality of routers may be connected on Local Access Network (LAN) side of a root router to form more subnets. The root router may sub-delegate IPv6 prefixes to the routers on the LAN-side through a dynamic host configuration protocol for IPv6 (DHCPv6) server. However, the root router usually can only specify a same prefix length for all the routers on the LAN side, and cannot individually assign different prefix length for different routers. Moreover, when the DHCPv6 server renews IPv6 prefix of the root router, a network administrator needs to manually calculate delegated IPv6 prefixes for the routers on the LAN-side.

### BRIEF DESCRIPTION OF THE DRAWINGS

Implementations of the present technology will now be described, by way of example only, with reference to the attached figures, wherein:

FIG. 1 is a block diagram of one embodiment of a root router.

FIG. 2 is a block diagram of one embodiment of a network topology.

FIG. 3 is a block diagram of one embodiment of functional modules of a prefix processing system of the root router of FIG. 1.

FIG. 4 is a flowchart of one embodiment of a prefix processing method.

FIG. 5 is a flowchart of one embodiment of a method for obtaining a first prefix length of the first router and a second prefix length of the second router.

FIG. 6 is a flowchart of another embodiment of a prefix processing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one”.

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

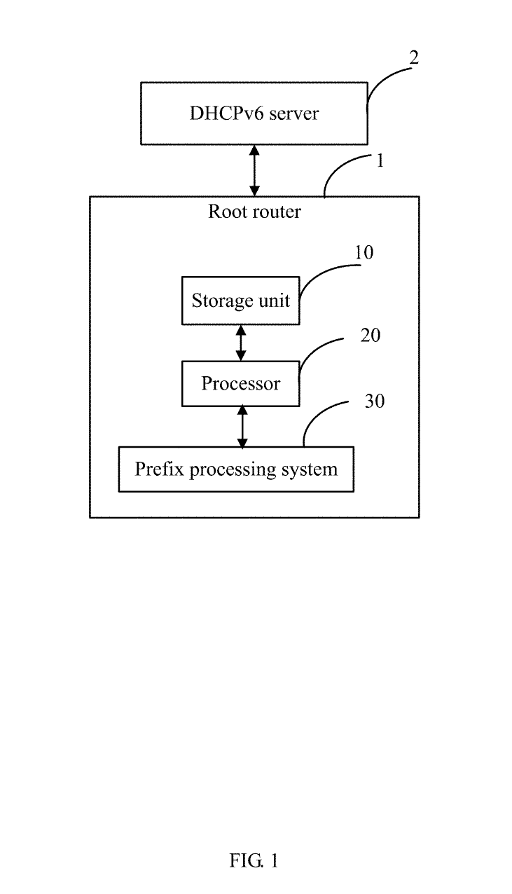

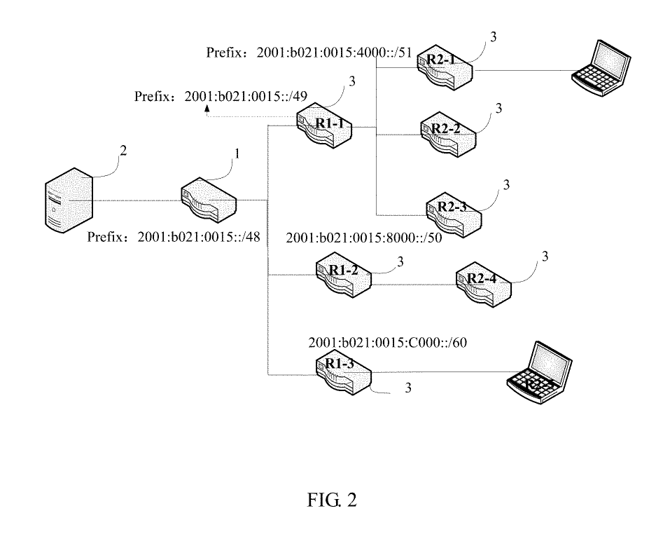

FIG. 1 illustrates a block diagram of an embodiment of a root router 1. In the embodiment, the root router 1 includes a storage unit 10, a processor 20, and a prefix processing system 30. The root router 1 is connected to a DHCPv6 server 2 via Internet. The root router 1 is located in a network topology (referring to FIG. 2). The network topology further includes other routers 3 on the LAN side of the root router 1, such as a first router and a second router. The root router 1 connects to the routers 3 to provide services.

In the embodiment, the root router 1 comprises a prefix delegation (hereinafter, PD) table, wherein the PD table is the means for storing a delegated IPv6 prefix of the root router 1, and a list of delegation information for the routers 3. Each entry of the list contains a router identifier and a bit boundary associated with the router identifier. The delegated IPv6 prefix has a specified prefix length. For example, a delegated IPv6 prefix “2001:b021:0015::/48” can have a delegated prefix length of 48, where the delegated IPv6 prefix and the prefix length are separated by a slash (/). The bit boundary is a decimal value that can be added to the delegated prefix length to obtain another prefix length for one of the routers 3. The root router 1 further comprises an address pool, which represents a plurality of contiguous and sequential IPv6 addresses available for allocation to the routers 3 according to the delegated IPv6 prefix.

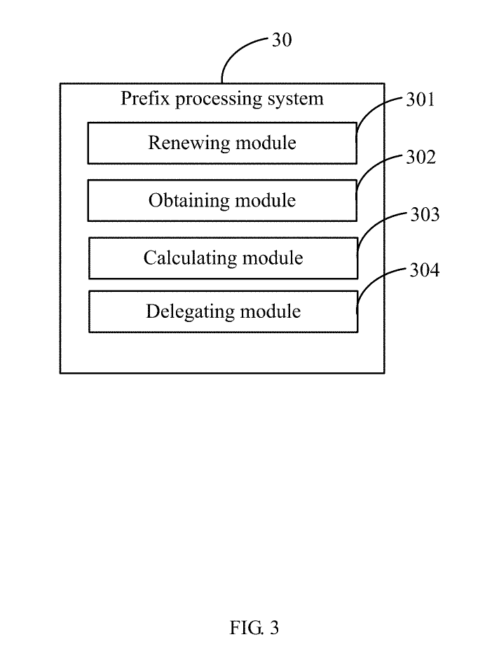

FIG. 3 illustrates a block diagram of an exemplary embodiment of functional modules of the prefix processing system 30. The prefix processing system 30 includes a renewing module 301, an obtaining module 302, a calculating module 303, and a delegating module 304. The one or more functional modules can include computerized code in the form of one or more programs that are stored in the storage unit 10, and executed by the processor 20 to provide functions of the prefix processing system 30.

The renewing module 301 renews the delegated IPv6 prefix of the root router 1 through the DHCPv6 server 2 and stores the delegated IPv6 prefix in the PD table.

The obtaining module 302 obtains a bit boundary from the PD table on a per-router identifier basis. There are at least two methods to configure the list of delegation information in the PD table. The methods are as follows.

The first method: the obtaining module 302 receives setting values for a router identifier and its associated bit boundary through a user interface, and stores the router identifier and the bit boundary in the PD table.

The second method: the obtaining module 302 receives a prefix delegation request from the router 3. In one embodiment, the prefix delegation request comprises the number of subnets the router 3 wants to create. The calculating module 303 then calculates a bit boundary according to the prefix delegation request and stores the bit boundary associated with the router identifier of the requesting router 3 in the PD table. The calculating module 303 calculates the bit boundary according to number of subnets requested of the router 3.

The calculating module 303 calculates the bit boundary according to the prefix delegation request following a preset rule. For example, the preset rule can calculate the bit boundary according to the following equation:

B=64−L−[log₂N],

where B corresponds with an integer representing the bit boundary, L corresponds with the delegated prefix length of the root router 1, and N corresponds with the number specified in the prefix delegation request. For example, the obtaining module 302 receives the prefix delegation request from the router 3 which specifies the creation of 3 subnets. Taking the delegated prefix length of the root router 1 as 48 for example, the calculating module 304 calculates that the bit boundary is equal to 14 for the router 3, according to the preset rule.

The delegating module 304 reserves a continuous portion of addresses within the address pool and delegates a prefix for the router 3 according to the delegated IPv6 Prefix of the root router 1 and the list of delegation information in the PD table.

Returning to FIG. 2 for example, the delegated IPv6 prefix of the root router 1 is “2001:b021:0015::/48” and the delegated prefix length is 48. The PD table contains the list of delegation informations as follows: {R1-1, 1; R1-2, 2; R1-3, 12}, where “R1-1”, “R1-2” and “R1-3” respectively represent the router identifier of the router 3 coupled to the root router, and values “1”, “2”, and “12” respectively represent the bit boundaries. For the router 3 with the router identifier “R1-1”, first, the delegating module 304 calculates the prefix length by adding the bit boundary “1” to the delegated prefix length of “48”. Then, the delegating module 304 reserves a continuous portion of addresses within the address pool beginning with “2001:b021:0015::” and delegates the prefix “2001:b021:0015::/49”. Similarly, the delegating module delegates the prefix “2001:b021:0015:8000::/50” which has a prefix length 50 to the router 3 of which the router identifier is “R1-2” associated with the bit boundary “2”. The prefix “2001:b021:0015:C000::/60”, having a prefix length of 60, is delegated to the router 3 of which the router identifier is “R1-3” associated with the bit boundary “12”. The routers 3 attached to the root router 1 may sub-delegate delegated IPv6 prefixes to the attached routers 3. For example, the router 3 “R1-1” can sub-delegate the IPv6 prefix “2001:b021:0015:4000::/51” to the router 3 “R2-1”.

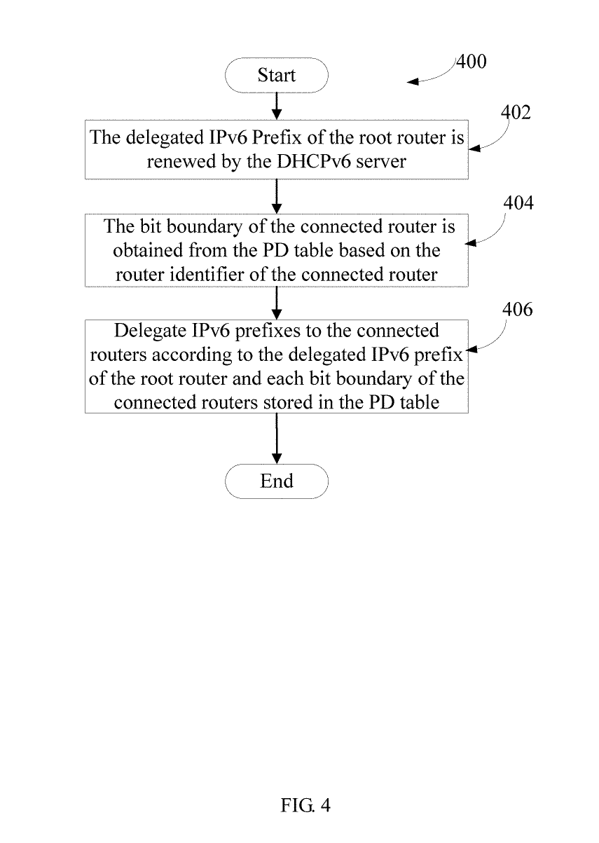

Referring to FIG. 4, a flowchart is presented in accordance with an embodiment of a method 400 for prefix processing executed by the processor 10. The method 400 is provided by way of example.

At block 402, the delegated IPv6 Prefix of the root router 1 is renewed by the DHCPv6 server 2.

At block 404, the bit boundary of the connected router 3 is obtained from the PD table based on the router identifier of the router 3.

At block 406, IPv6 prefixes to the connected routers 3 are delegated according to the delegated IPv6 prefix of the root router 1 and each bit boundary of the connected routers 3 is stored in the PD table.

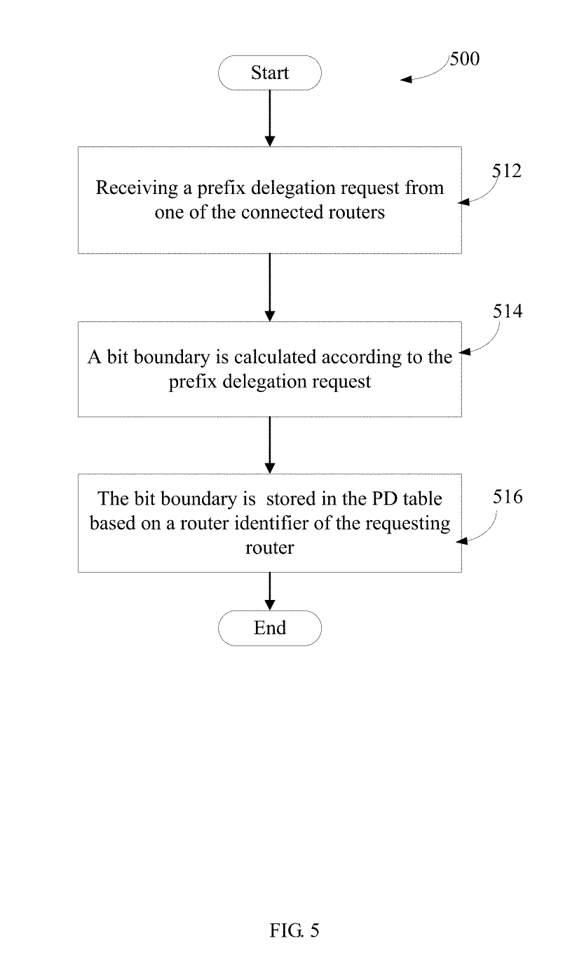

Referring to FIG. 5, a flowchart is presented in accordance with an embodiment of a method 500 for configuring the bit boundary of the router 3 in the PD table are executed by the processor 10. Each block shown in FIG. 5 represents one or more processes, methods, or subroutines, carried out in the exemplary method 500. Additionally, the illustrated order of blocks is by example only and the order of the blocks can be changed. The method 500 can begin at block 512.

At block 512, a prefix delegation request is received from one of the connected routers 3.

At block 514, a bit boundary is calculated according to the prefix delegation request.

At block 516, the bit boundary is stored in the PD table based on a router identifier of the requesting router 3.

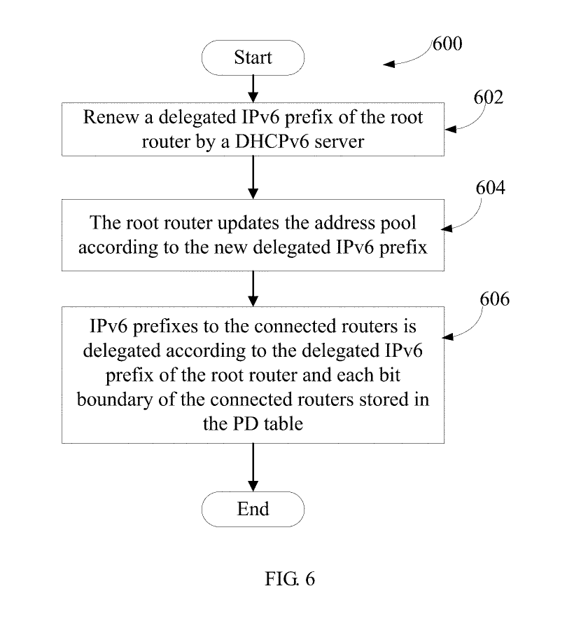

Referring to FIG. 6, a flowchart is presented in accordance with another embodiment of a method 600 for prefix processing executed by the processor 10. The method 600 is provided by way of example.

At block 602, the delegated IPv6 prefix of the root router 1 is renewed by the DHCPv6 server 2.

At block 604, the root router 1 updates the address pool according to the new delegated IPv6 prefix. The router further updates the list of the delegation information in the PD table according to the new delegated IPv6 prefix if a new delegated prefix length is different from the old delegated prefix length. For example, the old delegated prefix length is 48 and the new delegated prefix length is 52, the root router 1 updates each bit boundary field in the PD table to minus (52−48) from its original value in order to keep the same prefix length that delegated to the connected router 3. Another example, the root router 1 checks each bit boundary in the PD table whether the bit boundary added to the new delegated prefix length is exceed 64 prefix bits constraint. If the bit boundary added to the new delegated prefix length is exceed 64 prefix bits constraint, the root router 1 decreases the bit boundary to form a 64 bits prefix length and updates the bit boundary in the PD table.

At block 606, IPv6 prefixes to the connected routers 3 are delegated according to the delegated IPv6 prefix of the root router 1 and each bit boundary of the connected routers 3 is stored in the PD table.

The root router 1 can flexibly sub-delegate different IPv6 prefixes to the connected routers 3, and automatically maintain IPv6 prefix delegation without intervention of a network administrator.

The embodiments shown and described above are only examples. Many details are often found in the art such as the other features of a device and method for prefix processing. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for prefix processing, executed in a root router, the root router connects to at least one router, and the root router comprises a prefix delegation (PD) table, the method comprising:
renewing a delegated IPv6 Prefix of the root router by a dynamic host configuration protocol for IPv6 (DHCPv6) server;
storing the delegated IPv6 prefix in the PD table;
obtaining a bit boundary of the router from the PD table base on a router identifier of the router;
delegating an IPv6 prefix to the router according to the delegated IPv6 prefix of the root router and the bit boundary.

2. The method as claimed in claim 1, wherein the PD table stores the delegated IPv6 prefix of the root router, and a list of delegation information for the router.

3. The method as claimed in claim 2, wherein each entry of the list contains the router identifier of the router and the bit boundary associated with the router identifier.

4. The method as claimed in claim 3, wherein the bit boundary is a decimal value that can be added to a delegated prefix length of the delegated IPv6 prefix to obtain a prefix length for the router.

5. The method as claimed in claim 1, wherein the root router further comprises an address pool, the address pool represents a plurality of contiguous and sequential IPv6 addresses available for allocation to the router according to the delegated IPv6 prefix.

6. The method as claimed in claim 5, further comprising:
receiving a prefix delegation request from the router;
calculating the bit boundary according to the prefix delegation request;
storing the bit boundary associated with the router identifier of the router corresponding to the prefix delegation request in the PD table.

7. The method as claimed in claim 5, wherein the method further comprises:
updating the address pool according to the delegated IPv6 prefix.

8. A system for prefix processing, executed in a root router, the root router connects to at least one router, and the root router comprises a prefix delegation (PD) table, the system comprising:
at least one processor;
a storage unit; and
one or more programs that are stored in the storage unit and executed by the processor, the one or more programs comprising instructions for:
renewing a delegated IPv6 Prefix of the root router by a dynamic host configuration protocol for IPv6 (DHCPv6) server;
storing the delegated IPv6 prefix in the PD table;
obtaining a bit boundary of the router from the PD table base on a router identifier of the router;
delegating an IPv6 prefix to the router according to the delegated IPv6 prefix of the root router and the bit boundary.

9. The system as claimed in claim 8, wherein the PD table stores the delegated IPv6 prefix of the root router, and a list of delegation information for the router.

10. The system as claimed in claim 9, wherein each entry of the list contains the router identifier of the router and the bit boundary associated with the router identifier.

11. The system as claimed in claim 10, wherein the bit boundary is a decimal value that can be added to a delegated prefix length of the delegated IPv6 prefix to obtain a prefix length for the router.

12. The system as claimed in claim 8, wherein the root router further comprises an address pool, the address pool represents a plurality of contiguous and sequential IPv6 addresses available for allocation to the connected routers according to the delegated IPv6 prefix.

13. The system as claimed in claim 8, wherein the one or more programs further comprise instructions for:
receiving a prefix delegation request from the router;
calculating the bit boundary according to the prefix delegation request;
storing the bit boundary associated with the router identifier of the router corresponding to the prefix delegation request in the PD table.

14. The method as claimed in claim 13, wherein the one or more programs further comprise instructions for:
updating the address pool according to the delegated IPv6 prefix.
